(19) United States
(12) Patent Application Publication
(10) Pub. No.: US 2022/0274334 A1
(43) Pub. Date: Sep. 1, 2022

(54) CARRIAGE BEAM ARRANGEMENTS INCLUDING LUBRICATION DEVICES

(71) Applicant: HEWLETT-PACKARD DEVELOPMENT COMPANY, L.P., Spring, TX (US)

(72) Inventors: Jose Angel Villasante Bembibre, Sant Cugat del Valles (ES); Ricardo Oltra Ramirez, Sant Cugat del Valles (ES); Lluis Sole Enrech, Sant Cugat del Valles (ES); Alex Rius Laorden, Sant Cugat del Valles (ES)

(73) Assignee: HEWLETT-PACKARD DEVELOPMENT COMPANY, L.P., Spring, TX (US)

(21) Appl. No.: 17/635,130

(22) PCT Filed: Sep. 30, 2019
(86) PCT No.: PCT/US2019/053781

§ 371 Date: Feb. 14, 2022

(51) Int. Cl. B29C 64/227; B33Y 30/00; B41J 19/30; F16N 29/02

(52) U.S. Cl. CPC B29C 64/227; B33Y 30/00; B41J 19/305; F16N 29/02

(57) ABSTRACT

It is hereby disclosed a carriage arrangement, for example, for usage in a printing system. The arrangement comprising: a carriage: a carriage beam; a drive mechanism to move along a longitudinal direction of the carriage beam; and a lubrication device; wherein the carriage further comprises an attachment mechanism that, upon receipt of a lubrication signal, is to couple the carriage to the lubrication device and instruct the drive mechanism to move the carriage and the lubrication device along the carriage beam.

### BACKGROUND

In a printing operation of a printing device, a carriage, which is designed to carry an active component of a printing system such as, e.g., a printhead or a scanner, is moved relative to a print media item to perform an action associated to such media such as scanning it or depositing printing fluid to generate an image. The carriage is designed to move along a carriage guide and is to be propelled along the carriage guide by a drive mechanism.

A carriage such as that described above can be employed in printing devices for printing inks and in 3D printing devices wherein layers of build material are selectively solidified by layers with the aid of printing fluids that are printed to the layers of build material.

Similarly, in a scanning operation of a scanning device, which may be included in multifunction printers (MFPs) and other devices, a document to be scanned is placed on a transparent window for scanning. The document may be placed, face down (i.e., where “face” refers to the side of the document to be scanned) on one side of the window. A carriage, which has coupled thereto a scan bar including optics for scanning the document, may then be moved along the length of the opposite side of the window along a carriage beam. The carriage, and thus the scan bar, may be propelled along the carriage rod by a drive mechanism that, in an example, includes a motor and a flexible belt.

### BRIEF DESCRIPTION OF THE DRAWINGS

Various example features will be apparent from the detailed description which follows, taken in conjunction with the accompanying drawings, wherein:

FIG. 1 schematically shows a plan view of an example of a carriage arrangement over a print medium support.

FIG. 2 schematically shows a detail view of one of the edge sections of the carriage arrangement of FIG. 1.

FIG. 3 shows a perspective view of an example carriage arrangement.

FIG. 4 shows a flowchart of a lubrication method according to an example.

### DETAILED DESCRIPTION

In the following description and figures, some <example implementations of print apparatus, print systems, and/or printers are described. In examples described herein, a “printer” or a “printing system” may be a device to print content on a physical medium (e.g., paper, textiles, a layer of powder-based build material, etc.) with a print material (e.g., ink or toner). For example, the printer may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A printer may utilize suitable print consumables, such as ink, toner, fluids or powders, or other raw materials for printing. In some examples, a print apparatus may be a three-dimensional (3D) print apparatus. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

In one example, the present disclosure describes a carriage for use in a printing device. However, in another example, the carriage of the present disclosure can be incorporated in a scanning device.

The carriage disclosed herein may comprise or be otherwise coupled to a drive mechanism that is used to propel the carriage along a drive direction, the carriage may comprise a receptacle to receive. e.g., a print head, when printing a document, Similarly. in the case of a scanning device, the drive mechanism that is used to propel a carriage, to which is coupled a scanning element.

Moreover, the carriage is to move in a drive direction along a carriage beam. The carriage beam is a beam that extends longitudinally along the drive direction thereby defining the movement limits of the carriage and may have different configurations including its shape and material. In an example, the beam is a cylindrical element, however, other shapes include a triangular prism wherein one of the faces of the prism acts as a carriage beam along which the carriage slides.

It is therefore hereby disclosed a carriage arrangement comprising:
a carriage;
a carriage beam;
a drive mechanism to move along a longitudinal direction of the carriage beam; and
a lubrication device;
   wherein the carriage further comprises an attachment mechanism that, upon receipt of a lubrication signal, is to couple the carriage to the lubrication device and instruct the drive mechanism to move the carriage and the lubrication device along the carriage beam.

In an example, the attachment mechanism comprises an electromagnet, nonetheless, in other cases, another type of electromechanical coupling mechanism may be envisaged, e.g., an actuator that locks to a complementary part upon receipt of an actuation signal by the controller.

Moreover, the lubrication device may comprise a lubricant deposit fluidically coupled to a lubricating surface in contact with the carriage beam. In such a case, the lubricating deposit may, in an example, be coupled to the lubricating surface by capillarity.

In an example, the carriage arrangement may comprise or have a parking position defined, also, a holder may be provided in the parking position being the holder to maintain the lubrication device in the parking position. The parking position may be, e.., a position in the vicinity of an extreme of the carriage beam.

In a further example, the lubrication signal is issued by a controller of a printing system.

Moreover, the present disclosure refers to a printing system comprising:
a carriage beam;
a print medium support;
a carriage to slide along the carriage beam and extending over the print medium support,
a lubrication device to slide along the carriage beam; and
a controller;
   wherein the carriage comprises an attachment mechanism and wherein, upon determination of a lubrication operation, the controller is to position the carriage adjacent to the lubrication device and to issue a signal to the attachment mechanism as to couple the carriage and the attachment device.

In an example, the lubrication device is to slide along the carriage beam together with the carriage in the lubrication operation.

The lubrication device comprises, in an example, a lubricant deposit fluidically coupled to a lubricating surface in contact with the carriage beam.

Moreover, the system may be provided with a a parking position and a holder provided in the parking position being the holder to maintain the lubrication device in the parking position, e.g., when no lubrication operation is to be performed.

In an example, the parking position is located about an edge of carriage beam.

Also, the present disclosure refers to a lubrication method of a carriage beam in a printing system comprising a carriage associated to the carriage beam and a lubrication device in contact with the carriage beam as to apply a lubricant while moving along the carriage beam, the method comprising:
determine by a controller that a lubrication operation is to be performed;
move the carriage towards the lubrication device,
couple, by an attachment device of the carriage, the lubrication device and the carriage for example, a device comprising an electromagnet; and
move the carriage with the lubrication device along the carriage beam.

In an example, the method may further comprise to move the carriage with the lubrication device to a parking position and to decouple the lubrication device and the carriage.

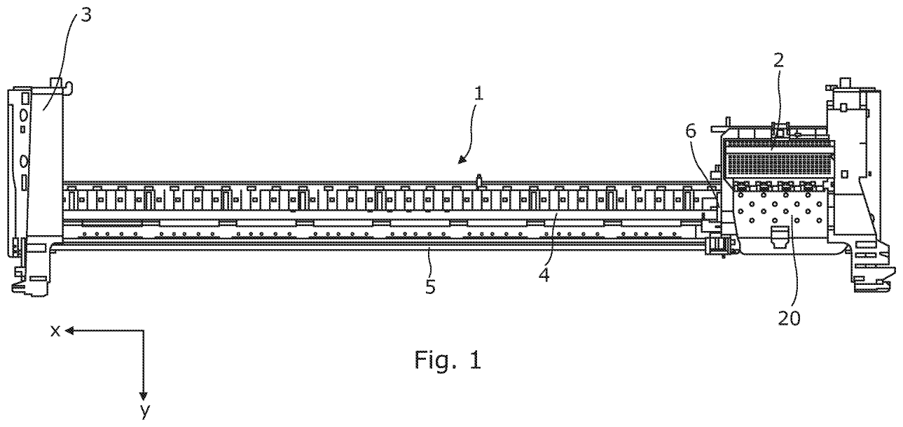

FIG. 1 shows an example of a carriage 2 for use as part of a printing system 1. In the example of FIG. 1, it is shown part of a printing system 1 wherein some elements have been removed to increase the intelligibility of the figure. The printing system comprises a carriage 2 comprises a receptacle 20 that is to house a printing element, e.g., a printhead or, in another example, a scanning element such as a scan bar. In any case, the printing system comprises a carriage beam 4 with a length that defines the travel distance of the carriage 2 in a swath direction, e.g., the drive direction X of FIG. 1, in particular, the carriage beam 4 may comprise a beam surface in contact with the carriage 2 so that the carriage slides along such carriage beam 4.

For ease of explanation, the following examples will be described with reference to a printing system in which the carriage moves in a direction along the width of the media, however. as explained above. the same principles apply to carriages that move along the length of a media, i.e., along a media path direction Y of FIG. 1.

In an example, the carriage 2 comprises or is otherwise coupled to a drive mechanism or an impelling mechanism. The drive mechanism may be part of the printing system, for example, may be coupled to the carriage 2 so that, in operation, the drive mechanism moves together with the carriage 2. In other examples, the drive mechanism is coupled to the carriage 2 by a belt arrangement so that the carriage 2 moves along the carriage beam 4 while the drive mechanism is fixed.

The carriage 2 is propelled by the drive mechanism to reciprocate along the carriage beam 4 as to perform an action on a media that, for example, may be supported in a media support 5. To ensure the integrity and quality of the system, the carriage arrangement may comprise means to lubricate the carriage beam 4.

In an example, a user may determine that a lubrication operation is needed on the carriage beam and instruct the printing system to perform such an operation. however, in other examples the printing system 1 may comprise means to determine that a lubrication operation is needed, for example, by analyzing the power needed by the drive system to move the carriage 2 along the carriage beam 4, if the power needed is above a threshold, a lubrication operation may be triggered by the system. In other examples, the lubrication operation may be performed upon request by a user and/or periodically, e.g., once the carriage has reciprocated a determined amount of times and/or after a determined amount of time has passed since a previous lubrication operation. The lubrication operation may be triggered by a controller and the controller may instruct the drive system and the carriage accordingly.

As mentioned above, the carriage beam 4 may have a longitudinal direction that corresponds to the drive direction X of the carriage. In an example, a parking position 3 may be defined on the vicinity of one of its edges of the carriage beam 4. The parking position 3 may receive a lubrication device when no lubrication operation is being performed on the carriage beam 4. In an example, the carriage arrangement may comprise means to hold the lubrication device on the parking position while the lubrication device detached from the carriage, such means may include, e.g., electromagnets, a mechanical assembly or electromechanical means for selectively hold the lubrication device in such position.

In the example of FIG. 1, a lubrication device 6 is coupled to the carriage 2 as to be propelled together with the carriage 2 to perform a lubrication operation on the carriage beam 4. The lubrication device 6 is detachably attached to the carriage by an attachment mechanism, e.g., an electromechanical attachment mechanism controlled by the controller.

The carriage arrangement of the present disclosure allows for the carriage to perform an operation such as e.g., a printing or scanning operation by reciprocating along the carriage beam 4 while the lubrication device 6 is stayed in the parkin position 3. Upon determination that a lubrication operation is to be performed, the controller may instruct the drive mechanism to move the carriage 2 towards the lubrication device. The carriage 2 may then be positioned adjacent to the lubrication device and the controller may instruct an attachment mechanism to couple the carriage 2 to the lubrication device 6. In an example, the attachment mechanism comprises an electromagnet that is instructed by the controller to couple or decouple the lubrication device and the carriage 2. In a further example, the electromagnet may be positioned between the lubrication device and a chassis of the printing system and be activated to maintain the lubrication device towards the chassis, in such a case, the controller may disactivate the electromagnet to allow the coupling between the lubrication device 6 and the carriage.

Also, the carriage 2 comprises a housing 7 that, in an example, is to receive a printhead, the printhead comprising a set of nozzles to eject a printing fluid towards the print medium. In other examples, the carriage 2 may be associated to a scan bar and may be moved along the length of a substrate as to scan it.

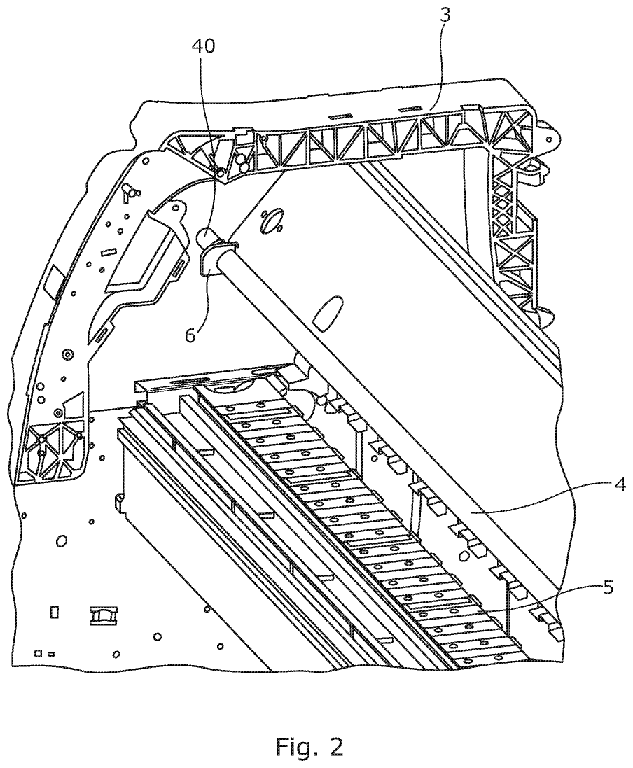

FIG. 2 shows a detailed view of an example of carriage arrangement, in particular, showing a longitudinal extreme of the carriage beam 4. In the example shown in FIG. 2 the carriage beam 4 extends longitudinally over the media support 5 as to allow the reciprocation of the carriage along a dimension of the media such as, e.g., the width of the media.

In an example, the carriage may be provided to be part of a system so that the carriage beam 4 is associated to a structural fixed element such as the piece 3 that may be part of the chassis of a printing system and may define the end-of-travel for the carriage 2.

The parking position of the lubrication device 6 may be, in an example, located in the neighborhood of the extreme 40 of the carriage beam 4, therefore, about the end-of-travel of the carriage beam. In an example, the neighborhood of the extreme 40 may be a position separated from the extreme 40 by a distance below 10% of the total length of the carriage beam.

As mentioned with reference to FIG. 1, it may be particularly beneficial to have an electromechanical attachment associated to the parking position as to maintain the lubrication device 6 therein when no lubrication operation is needed on the carriage beam 4. The electromechanical attachment may be controlled by the controller and is particularly beneficial to associate it to the parking position given that, being a fixed position, it allows for wired connections to electric supply and to communicate with the controller.

In a further example, electromechanical attachment means may be, in addition or instead, be located on the carriage 2 as to couple and decouple from the lubrication device 6.

Further auxiliary mechanical coupling components may be added to the system to improve reliability and to allow for a better coupling between the carriage and the lubrication device. Also, auxiliary mechanical coupling components may be provided to improve the coupling of the lubrication device in the parking location.

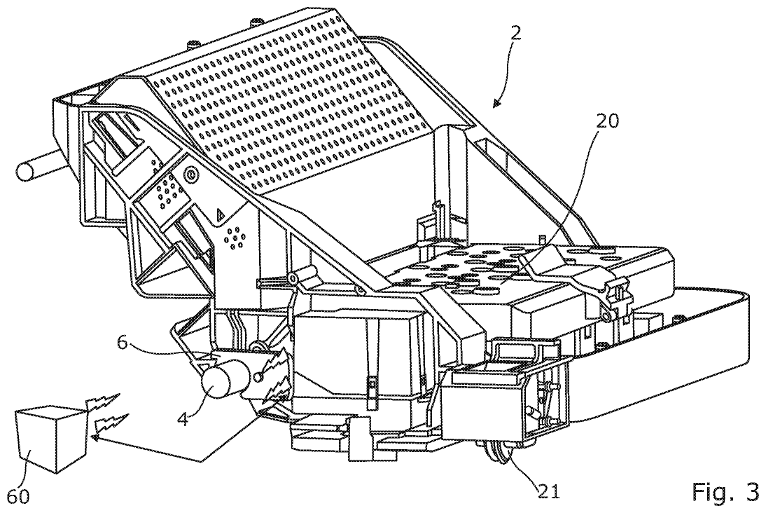

FIG. 3 shows an example of a carriage arrangement. In the example of FIG. 3 the lubrication device 6 is coupled to the carriage 2, i.e., an attachment mechanism between the carriage and the lubrication device has been instructed to couple them.

In the example, the carriage 2 is propelled by a drive mechanism (not shown) so that the carriage may slide along the carriage beam 4 in a reciprocating manner. In a first operating mode the carriage 2 may move along the carriage beam 4 while the lubrication device 6 is stayed in the parking position decoupled from the carriage 2. Then, when a lubrication operation is triggered, the carriage 2 may move towards the lubrication device 6 as to be adjacent to it and a controller may issue a trigger signal towards an attachment mechanism as to couple the carriage 2 and the lubrication device 6, then, a lubrication operation may be performed by reciprocating the carriage 2 while coupled to the lubrication device 6. Also, the carriage 2 may carry other elements to use in a printing/scanning process, for example, the carriage may comprise or be coupled to a cutter 21.

In the example provided in FIG. 3 the attachment mechanism may comprise an electromagnet 60. The electromagnet 60 may be provided in the parking position, i.e., between the lubrication device and a structure neighboring the edge of the carriage beam 4 as to hold the lubrication device in such a position when no lubrication is to be performed, then, when a lubrication operation is to be performed, the electromagnet may be instructed by the controller to deactivate thereby allowing a coupling between the carriage 2 and the lubrication device.

In another example of operation, the electromagnet 60 may be provided between the lubrication device 6 and the carriage 2 so that, upon an issuance of a trigger signal by the controller, the electromagnet may couple (or, at least, aid in coupling) the lubrication device 6 and the carriage 2.

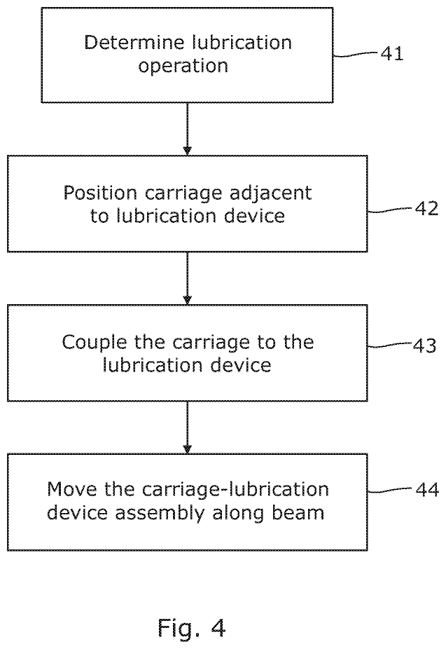

FIG. 4 shows an example of a method to perform a lubrication in a carriage arrangement. In the example of FIG. 4, a controller determines a lubrication operation 41. In an example, the controller may be provided with measurements performed by a sensor to identify that a lubrication operation should be performed, for example, the controller may be provided with the power needed by a drive mechanism to move the carriage along a beam, if the power exceeds a determined threshold, a lubrication operation may be triggered. In a further example, the trigger of the lubrication operation may be time-triggered, e.g., every determined amount of time a lubrication operation is triggered. In another example, the trigger of the lubrication operation may be use-triggered, e.g., the controller may be provided with information as to how many times the carriage has slide over the carriage beam, if the number exceeds a determined threshold number since the last lubrication operation, a lubrication may be triggered.

Then, the controller may instruct the carriage to position adjacent to the lubrication device 42 and then couple the carriage to the lubrication device 43. The coupling between the lubrication device and the carriage may be, for example, performed by an attachment mechanism, e.g., an electromechanical attachment such as an electromagnet. In an example, the controller may issue a coupling signal to the electromechanical attachment as to allow a coupling between the lubrication device and the carriage, i.e., that both of them jointly move along the carriage beam.

Finally the carriage-lubrication device arrangement may move along the carriage beam 43 thereby performing a lubrication operation of the carriage beam. The joint movement of the assembly may be performed by the drive mechanism that is to move the carriage in both operations, with the lubrication device being coupled and without the lubrication device being coupled.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teachings, It is to be understood that any feature described in relation to any one example may be used alone, or in combination with other features described, and may also be used in combination with any features of any other of the examples, or any combination of any other of the examples.

1. A carriage arrangement comprising:
a carriage;
a carriage beam;
a drive mechanism to move along a longitudinal direction of the carriage beam; and
a lubrication device;
wherein the carriage further comprises an attachment mechanism that, upon receipt of a lubrication signal, is to couple the carriage to the lubrication device and instruct the drive mechanism to move the carriage and the lubrication device along the carriage beam.

2. The carriage arrangement of claim 1, wherein the attachment mechanism comprises an electromagnet.

3. The carriage arrangement of claim 1, wherein the lubrication device comprises a lubricant deposit fluidically coupled to a lubricating surface in contact with the carriage beam.

4. The carriage arrangement of claim 3, wherein the lubricating deposit is coupled to the lubricating surface by capillarity.

5. The carriage arrangement of claim 1, further comprising a parking position and a holder provided in the parking position being the holder to maintain the lubrication device in the parking position.

6. The carriage arrangement of claim 5, wherein the parking position is located in the vicinity of an extreme of the carriage beam.

7. The carriage arrangement of claim 5, wherein the lubrication signal is issued by a controller of a printing system.

8. A printing system comprising:
a carriage beam;
a print medium support;
a carriage to slide along the carriage beam and extending over the print medium support,
a lubrication device to slide along the carriage beam; and
a controller;
wherein the carriage comprises an attachment mechanism and wherein, upon determination of a lubrication operation, the controller is to position the carriage adjacent to the lubrication device and to issue a signal to the attachment mechanism as to couple the carriage and the attachment device.

9. The system of claim 8, wherein the lubrication device is to slide along the carriage beam together with the carriage in the lubrication operation.

10. The system of claim 8, wherein the lubrication device comprises a lubricant deposit fluidically coupled to a lubricating surface in contact with the carriage beam.

11. The system of claim 8, further comprising a parking position and a holder provided in the parking position being the holder to maintain the lubrication device in the parking position.

12. The carriage arrangement of claim 8, wherein the parking position is located about an edge of carriage beam.

13. A lubrication method of a carriage beam in a printing system comprising a carriage associated to the carriage beam and a lubrication device in contact with the carriage beam as to apply a lubricant while moving along the carriage beam, the method comprising:
determine by a controller that a lubrication operation is to be performed;
move the carriage towards the lubrication device,
couple, by an attachment device of the carriage, the lubrication device and the carriage; and
move the carriage with the lubrication device along the carriage beam.

14. The method of claim 13, wherein the attachment device comprises an electromagnet.

15. The method of claim 13, further comprising to move the carriage with the lubrication device to a parking position and to decouple the lubrication device and the carriage.
